(19) United States
(12) Patent Application Publication
(10) Pub. No.: US 2016/0138336 A1
(43) Pub. Date: May 19, 2016

(54) PRIMARY AND SUBSIDIARY COMPLEX NUMBER TYPE A-SHAPED LADDER

(71) Applicant: Yung-Te LIN, Taoyuan (TW)

(72) Inventor: Yung-Te LIN, Taoyuan (TW)

(21) Appl. No.: 14/934,441

(22) Filed: Nov. 6, 2015

(30) Foreign Application Priority Data
Nov. 13, 2014 (TW) 103220120

(51) Int. Cl. E06C 1/18

(52) U.S. Cl. CPC E06C 1/18

(57) ABSTRACT

A primary and subsidiary complex number type A-shaped ladder includes a first handheld ladder and a second handheld ladders pivotally connected together, and at least one first extended ladder and one second extended ladders able to be assembled at the bottom ends of the first and the second handheld ladders. The first and the second extended ladders have their top ends respectively provided with a necking down fitting member, while the first and the second handheld ladders have the bottom ends of their vertical bars respectively provided with a fitting opening for the fitting member to be inserted therein. Thus, respective first extended ladder and respective second extended ladder can be stored or transported independently, or can be respectively assembled at the bottom ends of the first and the second handheld ladders to have the A-shaped ladder extended to a position high enough for use.

### BACKGROUND OF THE INVENTION

1. Field of the Invention

This invention relates to a service ladder, particularly to a primary and subsidiary complex number type A-shaped ladder, which is convenient in detachment, storage and transport and able to be extended to reach a position high enough for use in accordance with practical needs.

2. Description of the Prior Art

Generally, a conventional A-shaped or herringbone service ladder (collectively called as a service ladder hereinafter) is formed by having the top ends of two sets of handheld ladders pivotally connected together and has a foldable connecting rod fixed between the two sets of handheld ladders for restricting their stretching-open angles. When in use, the two sets of handheld ladders can be stretched open to form a triangular framework to facilitate a user to carry out decoration and repair work on the service ladder and after used, the two sets of handheld ladders can be folded up and drawn close to lean against each other.

As far as project contracting business is concerned, necessary equipment is mostly placed at a fixed business stronghold and if needed for work, the equipment will be transported to construction locations. Although the conventional service ladder can be collapsed to closely lean against each other, yet the conventional service ladder is unable to be moderately changed and adjusted in height in accordance with practical needs and hence, a comparatively long conventional service ladder is not easy to be transported and stored.

### SUMMARY OF THE INVENTION

In view of the drawback of the conventional A-shaped ladder mentioned above, the objective of this invention is to offer a primary and subsidiary complex number type A-shaped ladder, which is convenient in detachment, storage and transport and able to be assembled and extended to a position high enough for use.

The primary and subsidiary complex number type A-shaped ladder in the present invention includes a first handheld ladder and a second handheld ladder having their top ends pivotally connected together. The first and the second handheld ladders are respectively and oppositely allocated with two vertical bars having a plurality of rungs connected therebetween. This invention is characterized by having the two vertical bars of the first handheld ladder oppositely and pivotally fixed at the inner side of the two vertical bars of the second handheld ladder and having at least one first extended ladder and one second extended ladder able to be respectively assembled at the bottom ends of the first and the second handheld ladders. The first extended ladder and the second extended ladder are respectively provided with a necking down fitting member, while the first handheld ladder and the second handheld ladder have the bottom ends of their vertical bars respectively bored with a fitting opening for the fitting member to be inserted therein.

### BRIEF DESCRIPTION OF DRAWINGS

This invention will be better understood by referring to the accompanying drawings, wherein:

FIG. 1 is an exterior perspective view of a first preferred embodiment of a primary and subsidiary complex number type A-shaped ladder in the present invention;

FIG. 2 is an exploded perspective view of the first preferred embodiment of the primary and subsidiary complex number type A-shaped ladder in the present invention;

FIG. 3 is a perspective view of a first handheld ladder and a second handheld ladder combined together in the present invention;

FIG. 4 is a perspective view of a first extended ladder and a second extended ladder combined together in the present invention;

FIG. 5 is a schematic view of the first handheld ladder and the second handheld ladder having their top ends pivotally connected together in the present invention;

FIG. 6 is a schematic view of the first handheld ladder and the second handheld ladder in a folded state in the present invention;

FIG. 7 is an exploded perspective view of a second preferred embodiment of a primary and subsidiary complex number type A-shaped ladder in the present invention;

FIG. 8a is a partial exploded perspective view of the second preferred embodiment of the primary and subsidiary complex number type A-shaped ladder in the present invention;

FIG. 8b is a magnified view of the second preferred embodiment of an elastic-retractable positioning element in the present invention;

FIG. 8c is a schematic view of the second preferred embodiment of a fastening state of an airfoil fastener in the present invention;

FIG. 9 is a cross-sectional action view of the line A-A in FIG. 8a; and

FIG. 10 is another cross-sectional action view of the line A-A in FIG. 8a.

### DETAILED DESCRIPTION OF THE PREFERRED EMBODIMENT

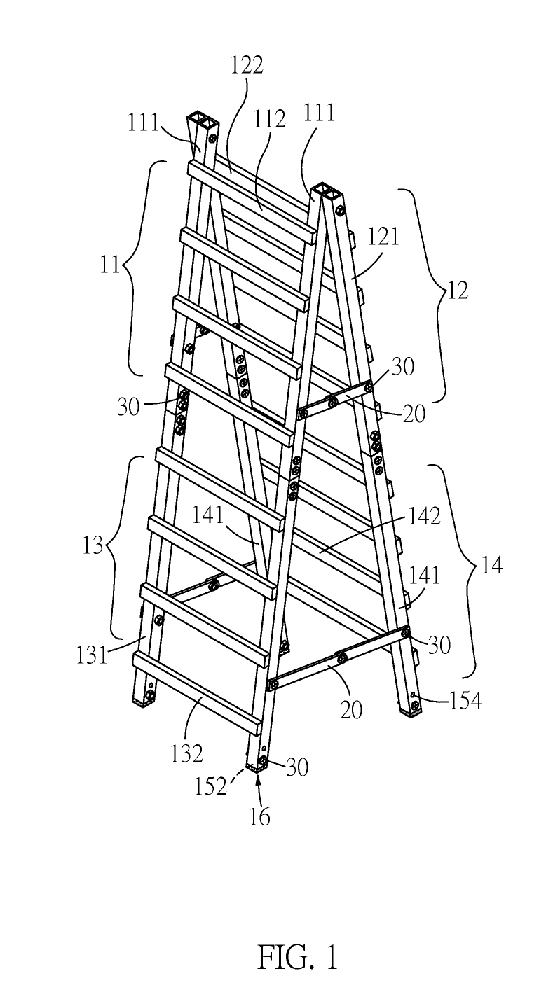

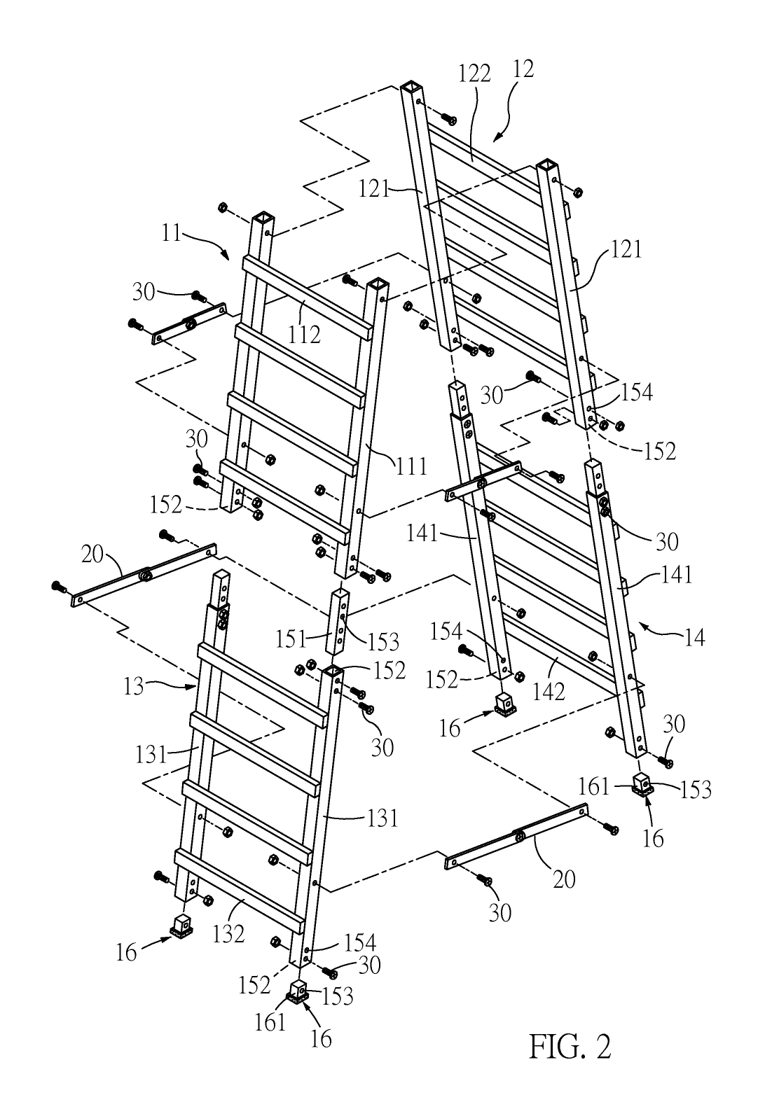

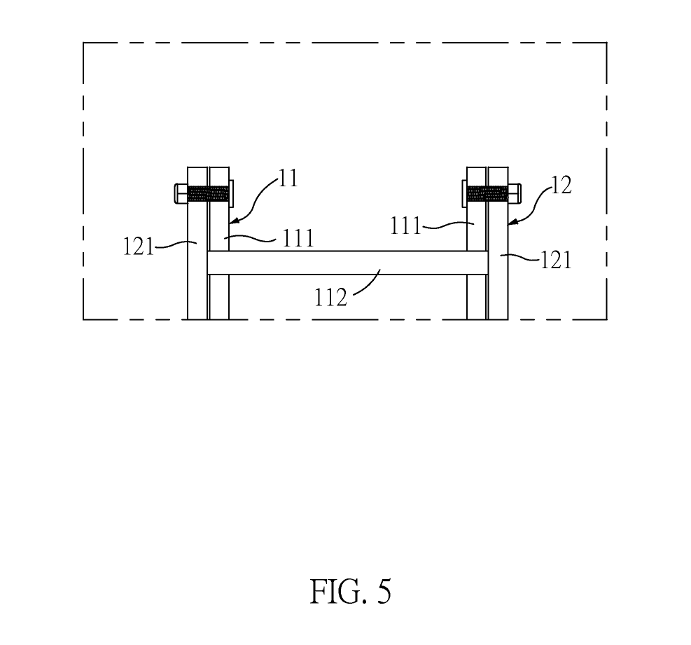

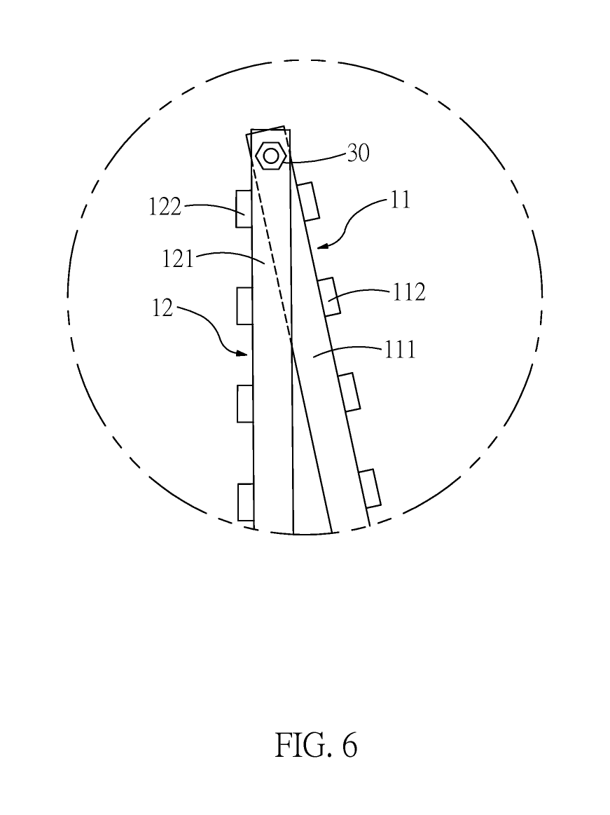

A first preferred embodiment of a primary and subsidiary complex number type A-shaped ladder, as shown in FIGS. 1-6, includes a first handheld ladder 11 and a second handheld ladder 12 respectively provided thereon with vertical bars 111 and 121 and a plurality of rungs 112 and 122. The vertical bars 111 of the first handheld ladder 11 and the vertical bars 121 of the second handheld ladder 12 respectively have their top ends pivotally connected with each other, as shown in FIG. 5, to enable the vertical bars 111, 121 to be folded and lean against each other, as shown in FIG. 6. Further, plural foldable connecting rods 20 are respectively fixed between the vertical bar 111 and the vertical bar 121, and the first handheld ladder 11 and the second handheld ladder 12 have their bottom ends respectively bored with a fitting opening 152 for assembling a first extended ladder 13 and a second extended ladder 14, and each fitting opening 152 is provided with external assembly holes 154. The first extended ladder 13 and the second extended ladder 14 are also respectively provided with vertical bars 131 and 141 and a plurality of rungs 132 and 142. The vertical bars 131 and 141 of the first and the second extended ladders 13, 14 can be respectively and correspondingly inserted and connected with the vertical bars 111 and 121 of the first handheld ladder 11 and the second handheld ladder 12. The first extended ladder 13 and the second extended ladder 14 have their top ends respectively provided with a necking down fitting member 151 able to be inserted and combined with the fitting opening 152 of the first and the second handheld ladders 11 and 12, and each fitting member 151 is bored with plural internal assembly holes 153. A plurality of fixing members 30 are respectively inserted through both the fitting member 151 and the fitting opening 152 of two vertical bars and inserted between the external assembly holes 154 and the internal assembly holes 153 to have the vertical bars 111 and 121 respectively combined together with the vertical bars 131 and 141 after the fitting members 151 are respectively inserted in the fitting openings 152. Further, the fitting openings 152 at the bottom ends of the vertical bars 131 and 141 are respectively inserted therein with an anti-skid pad 16 with a plug member 161, and the anti-skid pad 16 can be fixed in place by means of a fixing member 30 inserted through the external assembly holes 154 and the internal assembly holes 153. The fitting opening 152 of the vertical bars 111, 121 and 131, 141 can be a square cross section or a circular cross section in shape. In addition, the bottom ends of the vertical bars 131 and 141 of the first extended ladder 13 and the second extended ladder 14 can be respectively bored with a fitting opening 152 for the fitting member 151 of another vertical bar to be correspondingly inserted therein.

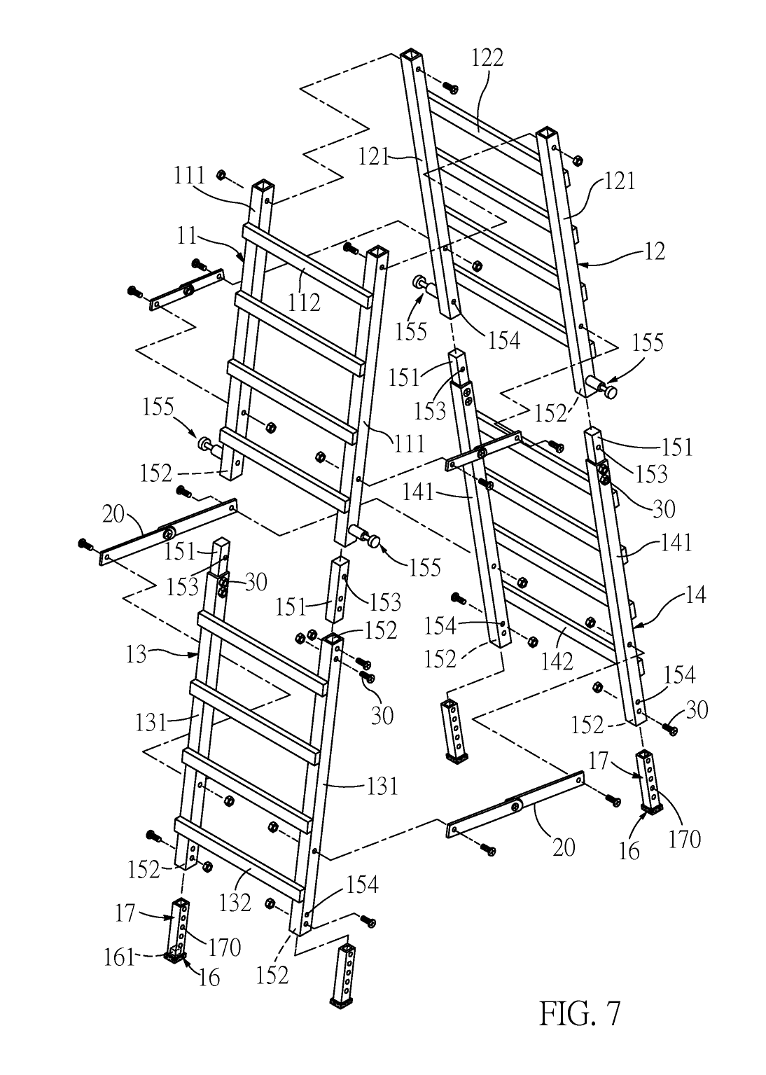

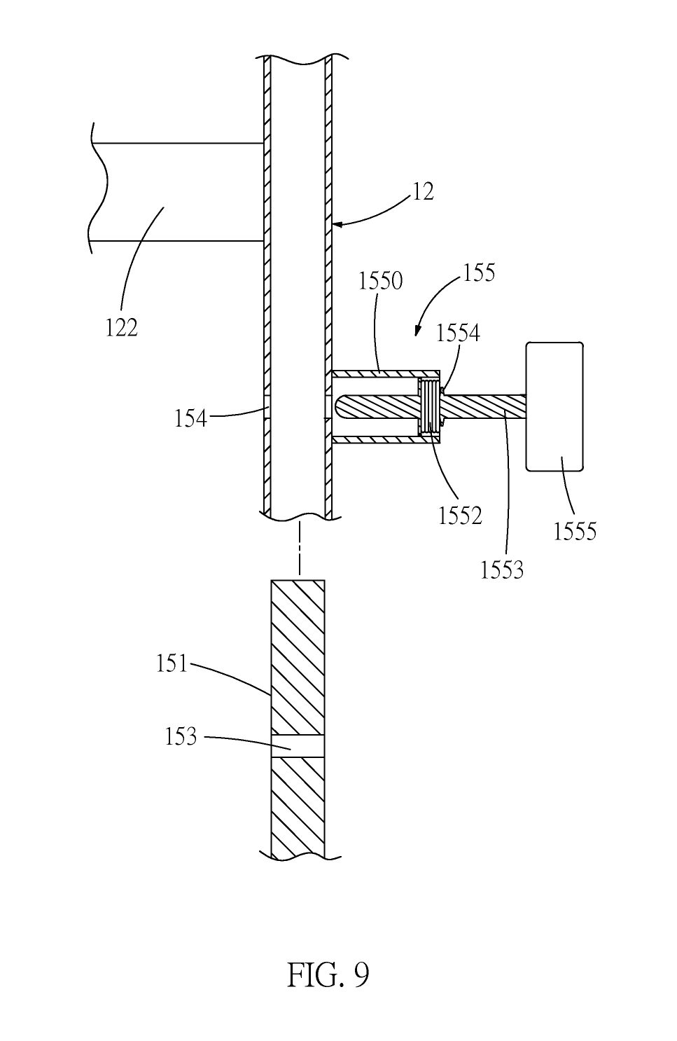

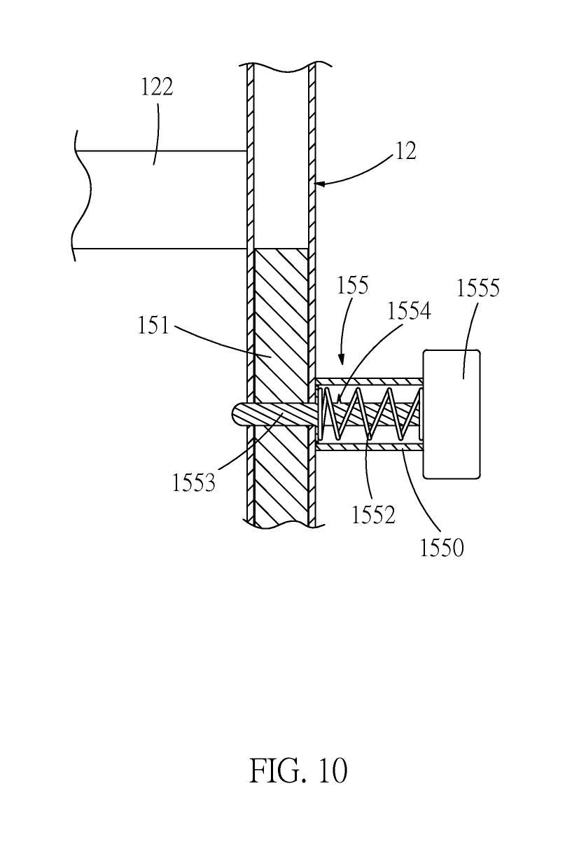

One special feature of this invention is that before the vertical bars of the first and the second extended ladders 13, 14 are correspondingly combined with the vertical bars of the first and the second handheld ladders 11, 12, that is, when the first and the second extended ladders are not yet assembled with the first and the second handheld ladders 11, 12, respective first extended ladder and respective second extended ladder can be stored or transported independently, and the first vertical bars 111 of the first handheld ladder 11 can be folded to lean against the inner side of the second vertical bars 121 of the second handheld ladder 12, as shown in FIG. 6. Thus, the volume of the first and the second handheld ladders 11, 12 can be greatly diminished after they are folded up, able to increase convenience of storage and enhance mobility of transport of the whole primary and subsidiary complex number type A-shaped ladder. Further, the plug member 161 is fixed thereon with a telescopic adjusting rod 17 with plural positioning holes 170 to enable the A-shaped ladder to be adjusted to stand steadily on an uneven ground, as shown in FIGS. 7-10.

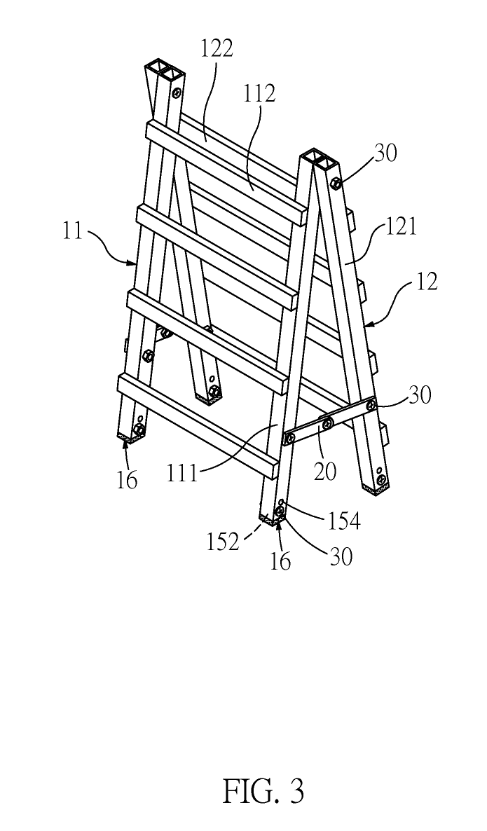

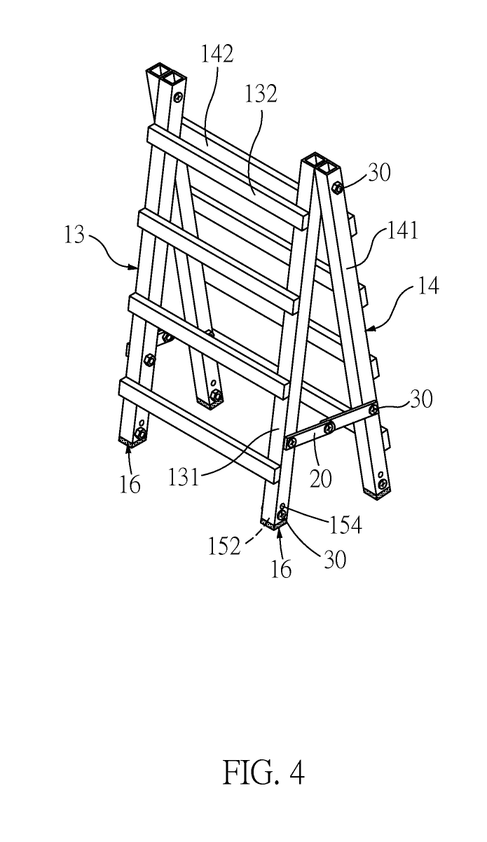

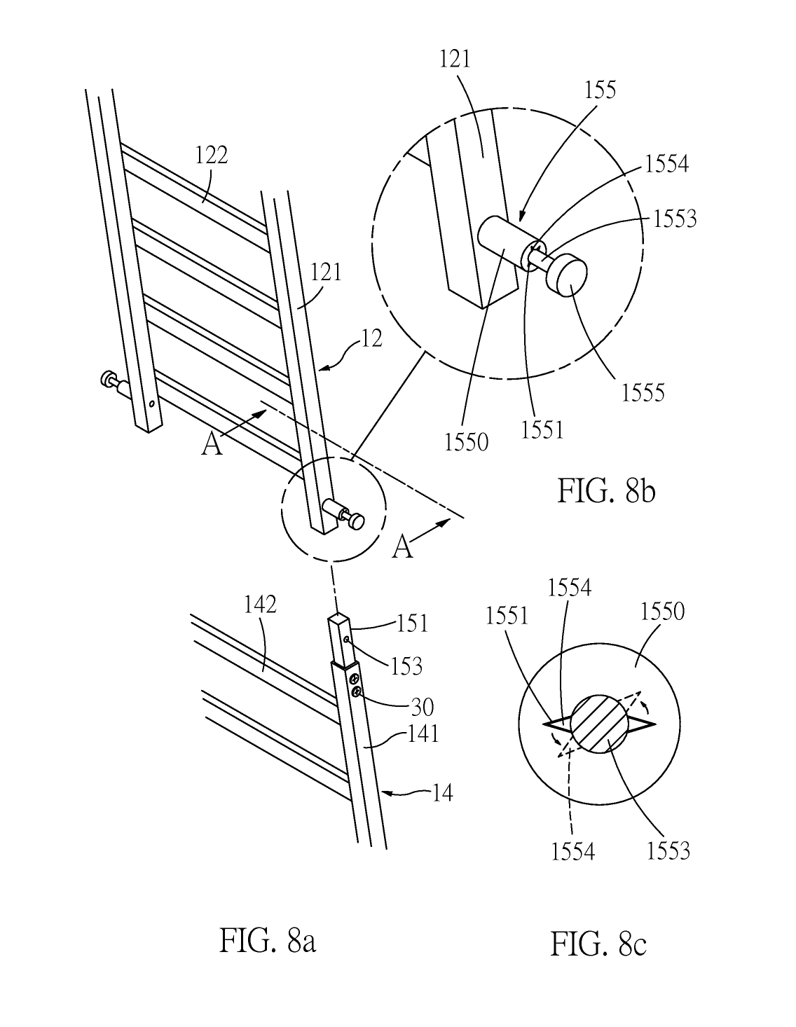

Specifically, the primary and subsidiary complex number type A-shaped ladder disclosed in this invention can have the first and the second extended ladders 13, 14 stored or transported independently under a condition that the first and the second extended ladders 13, 14 are not yet assembled with the first and the second handheld ladders 11, 12. When in use, according to practical demands, the first and the second handheld ladders 11 and 12 can be directly stretched open for use, and the first and the second extended ladders 13 and 14 can also be pivotally connected together and stretched open for use, thus able to make up two sets of A-shaped ladders, as shown in FIGS. 3 and 4. Or, the first and the second extended ladders 13 and 14 can be further assembled at the bottom ends of the first and the second handheld ladders 11 and 12 to make up a primary and subsidiary complex number type A-shaped ladder to have the whole primary and subsidiary complex number type A-shaped ladder extended to a position high enough for use. And even, a plurality of the first extended ladders 13 and the second extended ladders 14 of different lengths can further be reserved so that the first and the second extended ladders 13, 14 of a suitable length can be chosen to be assembled at the lower ends of the first and the second handheld ladders 11, 12 to have the whole primary and subsidiary complex number type A-shaped ladder extended to a proper height for use. Furthermore, the telescopic adjusting rods 17 provided at the bottom ends of the first and the second extended ladders 13, 14 can be adjusted according to different levels of the ground to enable the A-shaped ladder to stand steadily on the ground for tallying with demands of use of various working environments. Moreover, referring to FIGS. 7-10, the external assembly holes 154 at the lower side of the first and the second handheld ladders 11 and 12 can be respectively fitted therein with an elastic-retractable positioning element 155, as shown in FIGS. 8a-8c. The elastic-retractable positioning element 155 is provided with a casing 1550, an airfoil hole 1551, an elastic piece 1552, a telescopic rod 1553, an airfoil engage member 1554 and a handgrip 1555. Thus, by actuating the telescopic rod 1553 to extend and retract, the elastic-retractable positioning element 155 can easily be engaged in and disengaged from the internal assembly hole 153 of the fitting member 151 of the extended ladder, enabling the handheld ladders and the extended ladders to be combined together more easily.

While the preferred embodiments of the invention have been described above, it will be recognized and understood that various modifications may be made therein and the appended claims are intended to cover all such modifications that may fall within the spirit and scope of the invention.

What is claimed is:

1. A primary-auxiliary complex number type A-shaped ladder comprising a first handheld ladder and a second handheld ladder, said first and said second handheld ladders having their top ends pivotally connected together, said first and said second handheld ladders respectively provided with two opposite vertical bars, said two opposite vertical bars having a plurality of rungs connected therebetween; and
Characterized by said first handheld ladder having said two vertical bars correspondingly and pivotally fixed at an inner side of said two vertical bars of said second handheld ladder, and having at least one first extended ladder and one second extended ladder able to be respectively assembled at a lower side of said first handheld ladder and said second handheld ladder, said first extended ladder and said second extended ladder respectively provided with a necking down fitting member, said first handheld ladder and said second handheld ladder respectively formed with a fitting opening at a bottom end of said vertical bar for said fitting member to be inserted therein.

2. The primary and subsidiary complex number type A-shaped ladder as claimed in claim 1, wherein said vertical bars of said first extended ladder and said second extended ladder have their bottom ends respectively bored with a fitting opening for a fitting member of another vertical bar to be correspondingly inserted therein.

3. The primary and subsidiary complex number type A-shaped ladder as claimed in claim 1, wherein said vertical bars of said first extended ladder and said second extended ladder have their top ends respectively formed with at least one internal assembly hole that transversely passes through said fitting member, said vertical bars of said first handheld ladder and said second handheld ladder having their bottom ends respectively disposed with at least one external assembly hole that transversely passes through said fitting opening and that is aligned to said internal assembly hole, a plurality of fixing members transversely inserted through said fitting member and said fitting opening of two said vertical bars and inserted between said external assembly hole and said internal assembly hole that are aligned to each other.

4. The primary and subsidiary complex number type A-shaped ladder as claimed in claim 1, wherein said vertical bars of said first extended ladder and said second extended ladder have their top ends respectively provided with an internal assembly hole transversely passing through said fitting member, said vertical bars of said first handheld ladder and said second handheld ladder having their bottom ends respectively disposed with an external assembly hole that transversely passes through said fitting opening and that is aligned to said internal assembly hole, said vertical bars of each said first extended ladder and each said second extended ladder having their bottom ends respectively formed with a fitting opening for a fitting member of another vertical bar to be correspondingly inserted therein, said vertical bars of each said first extended ladder and each said second extended ladder having their bottom ends respectively bored with at least one external assembly hole transversely passing through said fitting opening and aligned to said internal assembly hole, plural fixing members transversely inserted in both said fitting member and said fitting opening of two said vertical bars and inserted between said external assembly hole and said internal assembly hole that are aligned to each other.

5. The primary and subsidiary complex number type A-shaped ladder as claimed in claim 1, wherein said primary and subsidiary complex number type A-shaped ladder is provided with four anti-skid pads, each said anti-skid pad provided thereon with a plug member, said plug member fixed with a telescopic adjusting rod at an upper side, said telescopic adjusting rod bored with plural positioning holes for said telescopic adjusting rod to be correspondingly inserted in said fitting opening.

6. The primary and subsidiary complex number type A-shaped ladder as claimed in claim 1, wherein at least one foldable connecting rod is fixed between two corresponding said vertical bars of said first handheld ladder and said second handheld ladder.

7. The primary and subsidiary complex number type A-shaped ladder as claimed in claim 1, wherein each said fitting member provided at a top end of said vertical bar of said first extended ladder and said second extended ladder is respectively an assembly element installed at the top end of said vertical bar.

8. The primary and subsidiary complex number type A-shaped ladder as claimed in claim 3, wherein said fixing member is a bolt.

9. The primary and subsidiary complex number type A-shaped ladder as claimed in claim 1, wherein said fitting member of each said vertical bar and said fitting opening of each said vertical bar are square cross sections in shape.

10. The primary and subsidiary complex number type A-shaped ladder as claimed in claim 1, wherein said fitting member of each said vertical bar and said fitting opening of each said vertical bar have a circular cross sectional form.

11. The primary and subsidiary complex number type A-shaped ladder as claimed in claim 1, wherein two said vertical bars disposed oppositely are consistent in distance from a top end to a bottom end, or disposed in a gradually enlarged mode.

12. The primary and subsidiary complex number type A-shaped ladder comprising a first handheld ladder and a second handheld ladder having their top ends pivotally connected together, said first and said second handheld ladders respectively having a plurality of rungs connected between two oppositely allocated vertical bars; and
Characterized by having said two vertical bars of said first handheld ladder oppositely and pivotally fixed at inner sides of said two vertical bars of said second handheld ladder and having at least one first extended ladder and one second extended ladder able to be respectively assembled at lower sides of said first handheld ladder said second handheld ladder, said first extended ladder and said second extended ladder respectively provided with a necking down fitting member, said first handheld ladder and said second handheld ladder having the bottom ends of said vertical bars respectively formed with a fitting opening for said fitting member to be inserted therein, said first extended ladder and said second extended ladder having the top ends of said vertical bars respectively bored with at least one internal assembly hole, said first handheld ladder and said second handheld ladder having the bottom ends of said vertical bars respectively formed with at least one external assembly hole aligned to said internal assembly hole, said first extended ladder and said second extended ladder having the bottom ends of said vertical bars respectively disposed with a fitting opening for a fitting member of another vertical bar to be inserted therein, said first extended ladder and said second extended ladder further having the lower ends of said vertical bars respectively bored with at least one external assembly hole aligned to said internal assembly hole, plural anti-skid pads respectively having a top side fixed with a plug member to be inserted in said fitting opening, said plug member having an upper side provided thereon with a telescopic adjusting rod, said telescopic adjusting rod bored with plural internal assembly holes aligned to said external assembly holes, plural fixing members respectively inserted through said fitting member and said fitting opening of two said vertical bars and inserted between said external assembly hole and said internal assembly hole that are aligned to each other, at least one foldable connecting rod fixed between two corresponding vertical bars of said first handheld ladder and said second handheld ladder.
